(19) United States
(12) Patent Application Publication
(10) Pub. No.: US 2013/0152014 A1
(43) Pub. Date: Jun. 13, 2013

(54) ELECTRONIC READER DISPLAY CONTROL

(71) Applicants: Khosro M. Rabii, San Diego, CA (US); Brian Momeyer, Carlsbad, CA (US)

(72) Inventors: Khosro M. Rabii, San Diego, CA (US); Brian Momeyer, Carlsbad, CA (US)

(73) Assignee: QUALCOMM INCORPORATED, San Diego, CA (US)

(21) Appl. No.: 13/323,338

(22) Filed: Dec. 12, 2011

(51) Int. Cl. G06F 3/048

(52) U.S. Cl. 715/785

(57) ABSTRACT

This disclosure describes techniques for reducing power consumption of a display device when operated to present text to a user, such as using an electronic book application. According to some aspects, the display device may determine a reading pane within a display screen of the display device, present text to a user in the determined reading pane, determine a reading speed of the user based on user input, and automatically advance the text in the determined reading pane based on the determined reading speed of the user.

According to other aspects of this disclosure, the display device may determine an area of interest within a reading pane, and modify operation of the display device to present text in one or more portions outside of a reading pane, to reduce power consumption of the display device, which may thereby improve a battery life of the display device.

### TECHNICAL FIELD

This disclosure relates to controlling a display device to present text to a viewer.

### BACKGROUND

In some examples, a display device (i.e., a device that includes a display) may be used to present readable text and/or images associated with text to a user of the device and/or other viewer. For example, a smartphone, tablet computer, electronic reader, or other device may execute one or more software applications that provide a user with text output via the display screen of the device, or another display controlled by the device, such as textual content from a book, magazine, news article or other source. In some examples, such a display device may operate using a limited power source, such as a battery. As described herein, the phrase “text” may be used to denote alphanumeric characters, as well as any images or diagrams associated with such alphanumeric characters.

### SUMMARY

This disclosure is directed to techniques for reducing power consumption of the device when the device is used to present text to a user, such as when the device executes an electronic book application (i.e., an e-reader application). These techniques include determining a reading pane in a display screen included in the mobile display device, and presenting text to a user in the determined reading pane. Determining the reading pane may include determining a size and/or location of the reading pane based on user input. These techniques also may include determining a reading speed of the user based on user input during a training interval, and automatically advancing the text presented in the determined reading pane based on the determined reading speed of the user. Automatically advancing the text may include automatically scrolling lines of the text and/or automatically turning pages of the text. These techniques also may include determining an area of interest within the determined reading pane that is used to present the text to the user, and modifying operation of the display device to present portions of the reading pane outside the determined area of interest. For example, modifying operation of portions of the reading pane outside of the area of interest may include reducing brightness, modifying font size or type, warping text, modifying resolution of text, modifying resolution of images or diagrams, modifying contrast or color of images or diagrams, modifying contrast of text, and/or modifying color of presented text outside the determined area of interest. In other examples, modifying operation of portions of the reading pane outside of the area of interest may include turning off (e.g., disconnecting from a power source) one or more portions of the display screen outside of the determined area of interest.

According to one example, a method of displaying text on a mobile display device is described herein. The method includes determining a reading pane of a display screen included in the mobile display device. The method further includes presenting text to a user in the determined reading pane. The method further includes determining a reading speed of the user based on user input during a training interval. The method further includes automatically advancing the text in the determined reading pane based on the determined reading speed of the user.

According to another example, a mobile display device configured to display text is described herein. The mobile display device includes a reading pane module configured to determine a reading pane of a display screen included in the mobile display device. The mobile display device also includes a display processor that presents text to a user in the determined reading pane. The mobile display device also includes a scroll speed determination module that determines a reading speed of the user based on user input during a training interval. The mobile display device also includes a scroll speed control module that automatically advances the text in the determined reading pane based on the determined reading speed of the user.

According to another example, a computer-readable storage medium that stores instructions is described herein. The instructions are configured to cause a computing device to determine a reading pane of a display screen included in a mobile display device. The instructions are also configured to cause the computing device to present text to a user in the determined reading pane. The instructions are also configured to cause the computing device to determine a reading speed of the user based on user input during a training interval. The instructions are also configured to cause the computing device to automatically advance the text in the determined reading pane based on the determined reading speed of the user.

As another example, a mobile display device is described herein. The device includes means for determining a reading pane of a display screen included in the mobile display device. The device further includes means for presenting text to a user in the determined reading pane. The device further includes means for determining a reading speed of the user based on user input during a training interval. The device further includes means for automatically advancing the text in the determined reading pane based on the determined reading speed of the user.

According to another example, a method of displaying text using a mobile display device is described herein. The method includes determining an area of interest within a reading pane presented via a mobile display device. The method further includes automatically advancing text presented in the determined area of interest. The method further includes modifying operation of the mobile display device to present text outside of the determined area of interest.

According to another example, a mobile display device is described herein. The mobile display device includes an area of interest module configured determine an area of interest within a reading pane presented via a mobile display device. The mobile display device further includes a scroll speed control module that automatically advances text presented in the determined area of interest. The mobile display device includes a display power module configured to modify operation of the mobile display device to present text outside of the determined area of interest.

According to another example, a computer-readable storage medium that stores instructions is described herein. The instructions are configured to cause a computing device to determine an area of interest within a reading pane presented via a mobile display device. The instructions are further configured to cause a computing device to automatically advance text presented in the determined area of interest. The instructions are further configured to cause a computing device to modify operation of the mobile display device to present text outside of the determined area of interest.

According to another example, a device configured to display text using a mobile display device is described herein. The device includes means for determining an area of interest within a reading pane presented via a mobile display device. The device further includes means for automatically advancing text presented in the determined area of interest. The device further includes means for modifying operation of the mobile display device to present text outside of the determined area of interest.

The details of one or more examples of this disclosure are set forth in the accompanying drawings and the description below. Other features, objects, and advantages of the techniques described herein will be apparent from the description and drawings, and from the claims.

### BRIEF DESCRIPTION OF DRAWINGS

FIG. 1 is a conceptual diagram that illustrates one example of a mobile display device configured to operate consistent with the techniques described herein.

FIG. 2 is a block diagram that illustrates one example of a mobile display device configured to operate consistent with the techniques described herein.

FIG. 3 is a block diagram that illustrates one example of an automatic scroll module of a mobile display device consistent with the techniques described herein.

FIG. 4 is a conceptual diagram that illustrates one example of a mobile display device configured to operate consistent with the techniques described herein.

FIG. 5-8 are conceptual diagrams that illustrate examples of reading panes that include an area of interest determined consistent with the techniques described herein.

FIG. 9 is a flow diagram that illustrates one example of a method of operating a mobile display device to reduce power consumption of the mobile display device consistent with one or more aspects of this disclosure.

FIG. 10 is a flow diagram that illustrates an example of another method of operating a mobile display device to reduce power consumption of the mobile display device consistent with one or more aspects of this disclosure.

### DETAILED DESCRIPTION

In general, this disclosure relates to techniques for reducing battery usage in a device, such as a mobile display device, during operation of an electronic book (i.e., e-reader) application. The mobile display device may comprise a dedicated electronic book device or a mobile handheld device that supports an electronic book application in addition to other applications. For example, a mobile display device that supports an electronic book application and other applications may comprise a so-called “smart” phone, a “smart” pad (i.e., tablet computer), or a similar mobile display device with a processor and display capable of providing a user or other viewer with readable text and/or images, such as one or more diagrams, associated with the text (e.g., an electronic book application), as well as other applications such as telecommunication, web browsing, email, gaming, audio/video, or other applications.

Some currently available dedicated electronic book devices include low power passive or reflective displays, e.g., ePaper or eInk displays, to present the book to the user. These low power displays may allow the dedicated devices to operate for weeks on a single battery charge. In other examples, mobile display devices may include high power active or self-illuminating displays, such as active matrix liquid crystal displays (AMLCDs) and active matrix organic light emitting diodes (AMOLEDs). Such high power displays, even when of a normal size and resolution, may only allow a mobile display device to operate for a relatively short time, e.g., a few hours, due to a limited power source, such as a battery. The relatively short battery-life of such mobile display devices with high power displays may be undesirable to a user, because he will not be able to read for more than a few hours without a subsequent charge. For example, the user may not be able to rely on the mobile display device to provide reading material during long flights, or other circumstances where the mobile display device may not be charged by a user.

The techniques of this disclosure enable a mobile display device to operate to present an electronic book or other application to present text to a user, while reducing an amount of power used to display the text in comparison to other techniques. These techniques include determining a reading pane in a display screen included in the mobile display device, and presenting text to a user in the determined reading pane. Determining the reading pane may include determining a size and/or location of the reading pane based on user input. These techniques also may include determining a reading speed of the user based on user input during a training interval, and automatically advancing the text presented in the determined reading pane based on the determined reading speed of the user. Automatically advancing the text may include automatically scrolling lines of the text and/or automatically turning pages of the text.

The technique of this disclosure may, also or instead, reduce power consumption of the mobile display device by determining an area of interest within the determined reading pane that is used to present the text to the user, and modifying operation of the display device to present other portions of the reading pane outside the determined area of interest. For example, modifying operation of the display device may include reducing brightness, contrast, and/or color of presented text outside the determined area of interest and/or turning off one or more portions of the display screen outside of the determined area of interest. In some examples, for mobile display devices with high power displays, the overall power savings from the techniques described herein may be between approximately 500 milliwatts (mW) and 1,000 mW, thereby extending the lifetime of the battery. As one example, mobile display device may include a battery with a 1000 milli amp hour (mAHr) battery and a 500 mA average load. According to this example, the techniques of this disclosure may provide for a 100 mA of power savings. According to this example, a battery life of the 1000 mAHr battery may be increased by substantially 30 minutes, which may represent a 20% increase in battery life.

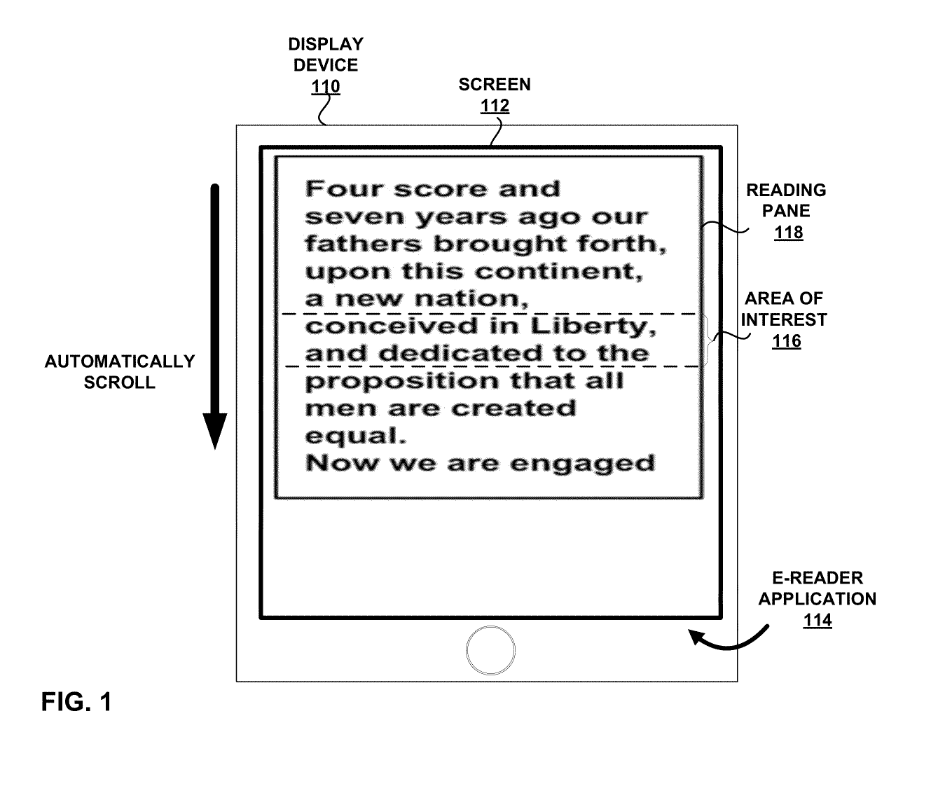

FIG. 1 is a conceptual diagram that illustrates one example of a mobile display device 110 configured to operate consistent with the techniques described herein. As shown in the example of FIG. 1, mobile display device (hereinafter “device” 110) includes a display screen 112 (hereinafter “screen” 112). Device 110 may be operable to execute one or more software applications (e.g., via a processor of device 110). In some examples, device 110 may be configured to, in response to one or more commands received from such an executing software application, control screen 112 to present one or more images.

In some examples, such a software application may control screen 112 to present a user with one or more images that comprise text as shown in the example of FIG. 1. For example, device 110 may include an e-reader application 114 that, based on one or more digital representations of textual content stored by device 110 or elsewhere, present readable text via screen 112. In some examples, e-reader application 114 may also be configured to receive user input to modify the presentation of readable text via screen 112. For example, e-reader application 114 may receive one or more touch screen gestures, voice commands, keyboard, mouse, or other form of user input, and in response, advance down or up down on a page of text, advance to a further page of text, or return to a previous page of text. According to one specific example, e-reader application 114 may receive a touch screen gesture that comprises a press detected on screen 112. According to this example, e-reader application may 114 may advance text based on relative force of the press detected on screen 112. In other examples, e-reader application 114 may receive user input via one or more non-touch gestures, such as ultrasonic, camera or infrared-based mechanisms for detecting user gestures based on movement of the user. This disclosure describes techniques for improving a user experience when using device 110 for purposes of reading text. For example, the techniques described herein may reduce an amount of power consumed by device 110 to present text to a user, which may thereby allow the user to use device 110 for longer periods of time between charging a power source of device 110, such as an internal battery of device 110.

For example, according to some aspects of this disclosure, device 110 may determine a reading pane 118 within screen 112. For example, device 110 may determine one of more of a size and/or location of reading pane 118, such as based on user input. In some examples, device 110 may determine a size of reading pane 118, as shown in FIG. 1, that may comprise less than all of display screen 112. In other examples not depicted in FIG. 1, the determined size of reading pane 118 may comprise all of display screen 112. Again, device 110 may determine the size and/or location of reading pane 118 based on receiving user input. For example, device 110 may determine the preferred size and/or location of reading pane 118 based on one or more single-touch, multi-touch, or other gestures detectable by device 110, or any other form of user input.

As depicted in FIG. 1, device 110 may operate to present text to a user in the determined reading pane 100. Device 110 may further determine a reading speed of the user. For example, device 110 may execute a training interval to determine a reading speed of the user based on user interface input during a training interval. For example, during the training interval, device 110 may present text to the user, and monitor a speed by which the user advances the text displayed in the reading pane 118. For example, device 110 may determine how fast a user has manually advanced text and/or turned pages of displayed text. According to one specific example, e-reader application 114 may receive a touch screen gesture that comprises a press detected on screen 112. According to this example, the user may advance text based on relative force of the press detected on screen 112. As another example, during the training interval, device 110 may automatically advance text presented to the user, and receive user interface input that indicates that the user desires to increase, or decrease, a scroll speed of the automatically advanced text. In some examples, such user interface input may include active user input, such as a touch-screen gesture, voice command, keyboard/mouse, or other user input that actively indicates adjustment to a scroll speed of automatically advanced text. In other examples, such user input may be passive user input. For example, device 110 may be configured to track a user's eyes while the user is reading, to determine a reading speed of the user. Accordingly, based on such user input, device 110 may automatically determine a reading speed of the user.

Once device 110 determines a reading speed of the user, device 110 may advance text in reading pane 118 based on the determined reading speed of the user. For example, device 110 may automatically scroll lines of the text as depicted in FIG. 1, and/or automatically turn pages of the text at a speed based on the determined reading speed of the user.

In some examples, automatically scrolling text presented via screen 112 as described herein may reduce power consumed by device 110 to present readable text. For example, by determining a reading speed of a user and automatically scrolling text based on the determined reading speed, device 110 may reduce user interaction with device 110 to operate e-reader application 114 (e.g., reduce receipt and/or processing of one or more commands to advance text and/or pages of text), which may thereby reduce power consumption of device 110 to present the text. For example, automatically scrolling text based on a determined reading speed may reduce a number of interrupts experienced by one or more processors executing e-reader application 114, which may reduce an amount of power consumption of device 110 (e.g., processor) for executing e-reader application 114.

According to some aspects of this disclosure, device 110 may also or instead reduce power consumption of device 110 based on determining an area of interest 116 within reading pane 118, and modifying operation of display in portions of screen 112 outside of the determined area of interest. For example, device 110 may receive user input indicating a size and/or location of the area of interest 116 within the reading pane. According to these examples, device 110 may modify operation of one or more portions of reading pane 118 in order to reduce power consumption of device 110. For example, device 110 may modify one or more portions of reading pane 118 outside of area of interest 116 by reducing a brightness of screen 112, reducing contrast of displayed text, and/or modifying a color of displayed text presented in one or more portions outside of the area of interest 116. As another example, device 110 may turn off one or more portions of screen 112 outside of area of interest 116. For example, where device 110 includes a device with a single screen as depicted in the example of FIG. 1, device 110 may disconnect at least a portion of screen 112 outside of the area of interest 116 from a power source. According to other examples where device 110 includes a device with multiple screens (not depicted in FIG. 1), device 110 may determine area of interest 116 on at least one of the multiple screens, and modify operation of other screens of device 110, as described above. For example, device 110 may reduce brightness, reduce contrast, and/or modify a color of presented text on the other screens of device 110, and/or turn off, the other screens.

In some examples, device 110 may uniformly modify presentation of images outside of area of interest 116. In other examples, device 110 may modify different areas (e.g., different lines of presented text) outside of area of interest 116 differently, depending on how close different areas are to area of interest 116.

In some examples, determining an area of interest 116 within reading pane 118, and modifying operation of one or more portions of screen 112 outside of area of interest 116 as described herein may reduce power consumption of device 110 when used to present text (e.g., to execute e-reader application 114). For example, power consumed to operate screen 112 may be reduced by modifying operation of device 110 to present images outside of area of interest 116, which may improve battery life of device 110, and thereby improve a user experience when using device 110 to read text. Furthermore, the various techniques described for modifying portions of display area 118 outside of area of interest 116 may cause presented text to be visually appealing to a user, which may thereby further improve the user's experience using device 110 to read text.

In some examples, the techniques described herein may be used alone, or in combination, to reduce power consumption of device 110 when used to present text to a user. For example, device 110 may reduce power consumption of device 110 by determine a reading speed of the user and automatically advancing text. Device 110 may, in some examples, further reduce power consumption of device 110 by determining an area of interest 116 within reading pane 114, and modifying the presentation of text outside of area of interest 116 as described herein. In other examples, device 110 may modify presentation of text outside of area of interest 116, without automatically advancing text based on a determined reading speed of the user.

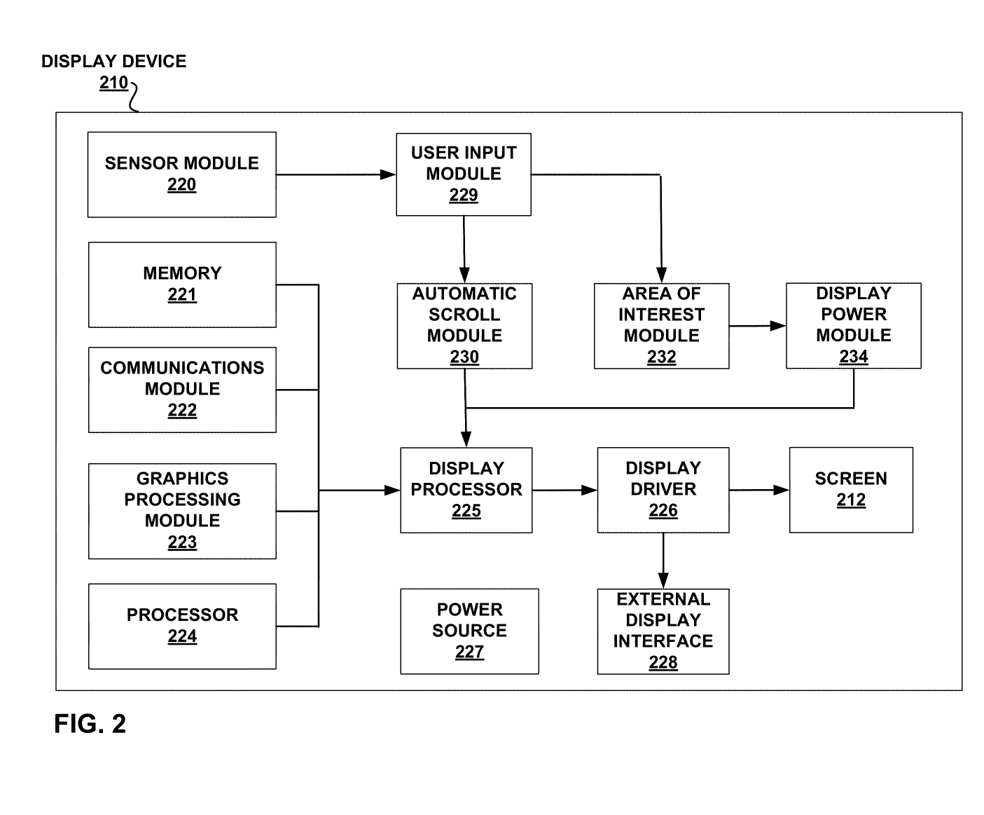

FIG. 2 is a block diagram that illustrates one example of a display device 210 (hereinafter “device” 210) configured to reduce power consumption of device 210 when operated to present text, consistent with one or more aspects of this disclosure. As shown in FIG. 2, device 210 includes a sensor module 220, a user input module 229, a memory 221, a communications module 222, a graphics processing module 223, a processor 224, a display screen 212 and a power source 227. Processor 224 may include one or more components of device 210 configured to execute instructions. For example, processor 224 may comprise one or more central processing units (CPU), application specific integrated circuits (ASICs), field programmable gat arrays (FPGAs), discrete logic components, or other component configured to execute instructions that control operation of device 210.

Memory 221 comprises one or more components of device 210 configured to store data and/or instructions, such as one or more magnetic storage components, optical storage components, random access memory (RAM) storage components, FLASH memory storage components, or any other component configured to store instructions and/or data. For example, memory 221 may store one or more software programs (e.g., e-reader application 114 depicted in FIG. 1) configured to operate device 210 to present text via display 212. Memory 221 may also or instead be configured to store data that represents text that may be presented via display 212. For example, memory 221 may store one or more digital representations of one or more books, magazines, news articles, electronic mail messages, blogs, or any other text that may be presented via display 212.

Communications module 222 may comprise one or more hardware and/or software components of device 210 configured to enable device 210 to communicate with one or more other devices. For examples, communications module 222 may comprise one or more components that enable one or more of wireless communication (e.g., WI-FI, BLUETOOTH, cellular network (e.g., 3G, 4G cellular network) or wired communication (e.g., ETHERNET). In some examples, communications module 222 may be used by device 210 to acquire one or more digital representations of text, as described above, that may be presented via screen 212.

Sensor module 220 may comprise one or more hardware and/or software components of device 210 configured to operate one or more sensors (not depicted in FIG. 2) of device 210. For example, sensor module 220 may comprise one or more hardware and/or software components of device 210 configured to operate one or more microphones, image sensors (e.g., camera sensor), accelerometer sensor, gyroscope sensor, single or multi-touch display sensors configured to detect user gestures performed at screen 212 or another portion of device 210, or any other type of sensor that device 210 may include.

Graphics processing module 223 may comprise one or more hardware and/or software components of device 210 configured to process graphics instructions (e.g., higher level graphics instructions such as, for example, one or more instructions according to the OPENGL standard) and generate image data that may be used to present images via screen 212. For example, graphics processing module 223 may comprise a graphics processing unit (GPU) and/or other components configured to process graphics. In some examples, graphics module 223 may process graphics based on graphics instructions received from one or software applications executing on processor 224. In other examples, graphics module 223 may process graphics based on graphics instructions received from memory 221 and/or communications module 222.

Power source 227 may comprise one or more components of device configured to store energy, such as electrical energy, that may be used to power one or more components of device 210. For example, power source 227 may comprise one or more batteries internal to device 210 that may be used to power device 210 when device 210 is not connected to an external power source, such as a wall outlet. In some examples, power source 227 may be a limited power source. In some examples, it may be desirable to decrease an amount of energy stored by power source 227 that is used to operate device 210, such that device 210 may be used for longer periods of time between being charged (e.g., by being connected to an external power source).

As also shown in FIG. 2, device 210 includes a user input module 229. User input module 229 may comprise one or more hardware and/or software components of device 210 configured to receive and/or process one or more indications of sensed information from sensor module 220, and communicate one or more indications of the sensed information to one or more other components of device 210. For example, user input module 229 may receive one or more indications of user interaction with screen 212, and determine that a user has performed one or more single and/or multi-touch gestures at screen 212 (or another surface of device) based on the indication of detected user interaction. According to this example, user input module 229 may send an indication of the determined single or multi-touch gesture to one or more other components of device 210. For example, user input module may send such an indication to one or more software applications executing on processor 224. The one or more software applications may control device 210 in response to such a received indication. For example, the one or more software applications may control one or more images presented via a display of device 210 responsive to such a received indication.

As depicted in FIG. 2, device 210 may also include a display processor 225, display driver 226, and an external display interface 228. Display processor 225 may be configured to receive, from one or more sources, one or more indications of images to be presented via screen 212, and send the received one or more indications to display driver 226. For example, display processor 225 may receive the one or more indications of images to be presented via screen from one or more of memory 221, communications module 222, graphics processing module 223, and/or processor 224 (e.g., one or more software applications executing on processor 224.

In some examples, display processor 225 may comprise one or more hardware and/or software components of device 210 configured to receive image data that represents pixels of a displayed image from the one or more sources, and store the received image data in a frame buffer accessible by display driver 226. Display driver 226 may comprise one or more hardware and/or software components of device 210 configured to control display screen 212 to present images based on such image data. For example, screen 212 may comprise one or more of a liquid crystal display (LCD display), a plasma display, a light emitting diode (LED) display, or any other type of screen capable of displaying images. Display driver 226 may comprise one or more hardware and/or software components of device 210 configured to control one or more display elements of the screen 212 to omit light consistent with image data received by display driver 226 (e.g., from display processor 225). In each case, if implemented in software, the components shown in FIG. 2 may comprise hardware, such as a processor, to execute the software.

In some examples, display driver 226 may also be configured to control one or more other displays communicatively coupled to device 210. For example, display driver 226 may control one or more other displays to present images via external display interface 228. External display interface 228 may comprise one or more hardware and/or software components of display device 210 configured to enable wired and/or wireless control of an external display. For example, external display interface 228 may comprise one or more components of device 210 that enable high definition multimedia interface (HDMI), digital video interface (DVI), composite, component, or other wired protocol for controlling an external display. In other examples, external display interface 228 may also or instead enable device 210 to wirelessly control an external display device. For example, external display interface 228 may operate as an interface to control external display via WI-FI, BLUETOOTH, cellular, or other form of wireless communication supported via communications module 222.

As also depicted in FIG. 2, device 210 may include one or more of an automatic scroll module 230, an area of interest module 232, and a display power module 234 consistent with the techniques described herein. Generally speaking, automatic scroll module, reading pane module 346, and display power module 234 may operate to reduce power consumption of device 210 when operated to present text.

Automatic scroll module 230 may be operable to determine a reading pane 118 of screen 212 for presentation of text, determine a reading speed of a user, and control the presentation of text in the determined reading pane 118 to automatically scroll the text based on the determined reading speed of the user.

In some examples, automatic scroll module 230 may also determine a complexity of text to be presented via screen 212, and adjust a speed at which the determined text is automatically scrolled, based on the complexity of the presented text, as well as the determined reading speed of the user. For example, if automatic scroll module 230 determines that text to be presented is more complex, automatic scroll module 230 may reduce a speed at which the text is automatically scrolled. However, if automatic scroll module 230 determines that text to be presented is less complex, automatic scroll module may increase a speed at which the text is automatically scrolled.

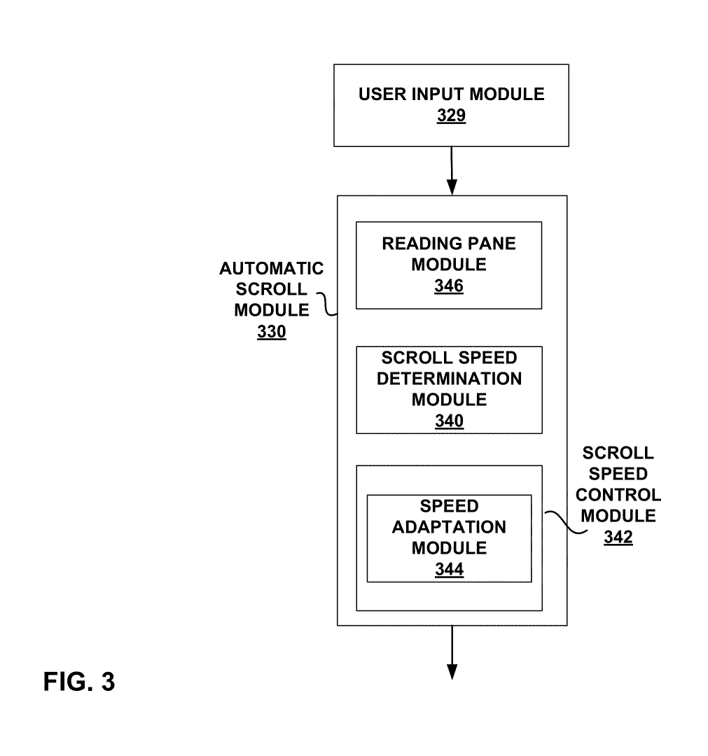

FIG. 3 is a block diagram that illustrates one example of an automatic scroll module 330 of a display device such as display device 210 depicted in FIG. 2. As shown in the example of FIG. 3, automatic scroll module 330 includes a reading pane module 346. Reading pane module 346 may determine a reading pane (e.g., reading pane 118 depicted in FIG. 1) of screen 212. According to the techniques described herein, reading pane module 346 may, in some examples, determine a reading pane 118 that comprises less than all of screen 212. In some examples, reading pane module 346 may determine a size and/or location of reading pane 118. For example, reading pane module 346 may determine a number of lines of presented text to be included in reading pane 118, a size of the reading pane 118 relative to a size of screen 212, and/or a position of reading pane 118 (e.g., top, bottom, or middle) within screen 212.

In some examples, as shown in FIG. 2, reading pane module 346 may determine a size and/or location of reading pane 118 based on user input received via user input module 229. For example, reading pane module 346 may receive one or more indications of single or multi-touch gestures, voice input, mouse, keyboard, or other form of input to determine a size and/or location of reading pane 118. As one specific example, reading pane module 346 may receive from sensor module 229 an indication of a detected of a multi-touch gesture that comprises a two-finger pinch gesture to reduce a size of the reading pane, or a two-finger spread gesture to increase a size of the reading pane 118. As another specific example, reading pane module 346 may receive from sensor module 229 an indication of a single or multi-touch gesture that indicates movement of a location of reading pane 118 up or down with respect to reading pane 118.

As also depicted in FIG. 3, automatic scroll module 330 may also include a scroll speed determination module 340 (hereinafter SSDM 340). SSDM 340 may determine a reading speed of a user, and determine an automatic scroll speed for text to be presented to the user based on the determined reading speed. For example, SSDM 340 may be operable to execute a training interval to determine a desired reading speed of a user.

During such a training interval, SSDM 340 may learn the reading speed of a particular user based on user input. The training interval, for example, may occur over a fixed period of time, a fixed number of pages of text, or until a minimum amount of data is collected to determine the user's reading speed.

The user may input data to SSDM 340 during the training interval via one or more user interfaces of device 210 (e.g., via user input module 229). For example, the user interfaces may include one or more of a touch screen display, a pressure-sensitive touch screen display, an external or internal mouse, an external or internal keyboard, and external or internal microphone.

The user may provide user input according to one or more training mechanisms. For example, during the training interval, SSDM 340 may track one or more of manual line scroll and/or page turn commands received from via user input module 229 as the user reads the text in a conventional manner. As another example, during the training interval, a user may provide constant feedback regarding his/her reading speed to the display controller via one or more user interfaces. In the case of a touch screen user interface, the user may slide his/her finger along the side of the screen to track how quickly each line of text is read. As another example, the user may provide feedback based on an amount of pressure applied to screen 312. As a further example, during the training interval, automatic scroll module 330 may automatically advance the text at a default speed and the user may increase or decrease the speed at which the text is advanced to match his/her reading speed. In any case, once the training interval ends, SSDM 340 may determine the reading speed of the user, and determine a speed at which text may be automatically scrolled that may be comfortable for the user.

As depicted in FIG. 3, automatic scroll module 330 further includes a scroll speed control module 342 (hereinafter “SSCM 342”). Once SSDM 340 determines an automatic scroll speed during a training interval as described above, SSCM 342 may begin automatically advancing presented text by scrolling lines of the text and/or turning pages of the text based on the determined reading speed. For example, SSCM 342 may be operable to communicate with display processor 225 and/or e-reader application 114 to cause text to be automatically scrolled at the automatic scroll speed determined by SSDM 340.

In some examples, SSCM 342 may automatically scroll text by advancing presented text in a direction consistent with how the written human language of the text is typically read. For example, in the English language and many other languages, SSCM 342 may advance lines of text upward at a rate consistent with a determined reading speed of a user, as shown in the example of FIG. 1. For other written human languages, SSCM 342 may automatically advance text in a different direction consistent with how the particular language is typically read.

As also depicted in FIG. 3, in some examples, SSCM 342 may also include a speed adaptation module 344. Speed adaptation module 344 may be configured to adapt a speed at which text is automatically scrolled based on a complexity of the text. For example, speed adaptation module 344 may increase an automatic scroll speed of text that is relatively less complex, and/or decrease an automatic scroll speed of text that is relatively more complex. In some examples, speed adaptation module 344 may determine a relative lexical complexity of text to be automatically scrolled based on one or more algorithms for determining lexical complexity of written language.

For example, speed adaptation module 344 may utilize the Flesch Reading Ease Index to determine a lexical complexity of text to be presented. The Flesch Reading Ease Index may determine lexical complexity based on the equation 206.835−(1.015×Average Sentence Length)−(84.6×Average Syllables per Word). According to these examples, if speed adaptation module 344 determines that text to be presented has a relatively high score according to the Flesch Reading Ease Index, speed adaptation may decrease an automatic scroll speed for the text. However, if speed adaptation module 344 determines that text to be presented has a relatively low score according to the Flesch Reading Ease Index, speed adaptation module 344 may decrease an automatic scroll speed for the text. In some examples, speed adaptation module 344 may determine whether to adjust speed of text scrolling, and/or an amount of adjustment to make to speed of text scrolling, based on comparison of the Flesch Reading Ease Index score to one or more predetermined or adaptively determined thresholds.

User input module 329, automatic scroll module 330, reading pane module 346, scroll speed determination module 340, scroll speed control module 342, speed adaptation module 344, and other modules described in this disclosure may be implemented in hardware and/or software. In each case, however, such modules may comprise independent hardware units, such as processors, or portions of common hardware units, or independent or common hardware units executing software and/or firmware to perform at least some of the functions described in this disclosure. Accordingly, such modules should not be considered to be software per se, in that hardware for execution of such software, such as general purpose or specialized processing circuitry, is required.

Referring back to FIG. 2, once an automatic scroll speed (and/or an adjusted automatic scroll speed) has been determined as described above, automatic scroll module 230 may operate to cause the text to be automatically scrolled at the determined speed. For example, automatic scroll module 230 may communicate one or more indications of a determined scroll speed to an e-reader application 114 executing on processor 224, graphics processing module 223, and/or display processor 225 to cause text presented via screen 212 to be automatically scrolled consistent with the determined scroll speed. In some examples, while text is being automatically scrolled, device 210 (i.e., e-reader application 114 executing on processor 224) may also provide one or more manual controls to allow the user to manually slow down, pause, and speed up the automatic scrolling of the text (e.g., via user input module 229). According to one specific example, device 210 may receive a touch screen gesture that comprises a press detected on screen 212. According to this example, device 210 may advance text based on relative force of the press detected on screen 212.

Automatic scroll module 230 may operate to reduce power consumption of device 210 to present text, by determining a reading speed of a user and automatically scrolling text at a speed based on the determined reading speed. For example, by switching from manual page control to automatic page control as described herein, a user may no longer need to interact with device 200 via one or more user interfaces to scroll through lines of the text and/or turn pages of the text. In some examples, such conventional user interfaces that may be used to manually advance text in an electronic book application may interrupt the one or more components of device 210, such as processor 224 and/or display processor 225, in order to perform a line scroll or page turn command.

In some examples according to the techniques described herein, a user may not interact with such conventional user interfaces while text is being automatically scrolled as described herein. As such, because processor 224 and/or display processor 225 may not process such conventional user interfaces, power consumption of processor 224 and/or display processor 225 to present the text. In addition, processor 224 and/or display processor 225 may automatically advance the text without being interrupted, which may also reduce power consumption of processor 224 and/or display processor 225. In some examples, reducing and/or eliminating the management and processing associated with the user interfaces used to manually advance text may provide substantial power savings for the device 110 to present text to a user.

Again referring to FIG. 2, in some examples, device 210 may also include an area of interest module and a display power module 340. Area of interest module 232 may determine an area of interest 116 (e.g., within reading pane 118) of screen 212. According to the techniques described herein, area of interest module 232 may, in some examples, determine a reading pane 118 that comprises less than all of screen 212 and/or less than all of reading pane 118.

In some examples, area of interest module 232 may determine a size and or location of area of interest 116. For example, area of interest module 232 may determine a size of an area of interest 116 that includes a number of lines of text presented in reading pane 346, and/or a position of area of interest 116 (e.g., top, bottom, or middle) within reading pane 118.

In some examples, as shown in FIG. 2, area of interest module 232 may determine a size and/or location of area of interest 116 based on user input received via user input module 229. For example, area of interest module 232 may receive one or more indications of single or multi-touch gestures, voice input, mouse, keyboard, or other form of input to determine a size and/or location of area of interest 116. As one specific example, area of interest module 232 may receive from sensor module 229 an indication of a detected of a multi-touch gesture that comprises a two-finger pinch gesture to reduce a size of the reading pane, or a two-finger spread gesture to increase a size of the area of interest 116. As another specific example, area of interest module 232 may receive from sensor module 229 an indication of a single or multi-touch gesture that indicates movement of a location of area of interest 116 up or down with respect to screen 212.

Display power module 240 may receive from area of interest module 232 at least one indication of an area of interest determined by area of interest module 232, as described above. Display power module 240 may modify the presentation of images and/or operation of screen 212 in portions of screen 212 outside of the determined area of interest 116, to reduce power consumption of device 210 when operated to display text. For example, display power module 234 may operate to modify presentation of one or more lines of text presented outside of the determined area of interest 116. For example, display power module 234 may modify a brightness, font and/or size, warping, resolution, contrast ratio, color, or other characteristic of text and/or image(s) associated with text, presented outside of the determined area of interest 116. In other examples, display power module 234 may also or instead turn off one or more portions of screen 212 outside of the determined area of interest 116. In this manner, device 210 may operate to present readable text to a user, while reducing power consumption of one or more components of device 210, such as processor 224, display processor 225, display driver 226, and/or screen 212, which may improve a battery life of device 210 when operated to present text.

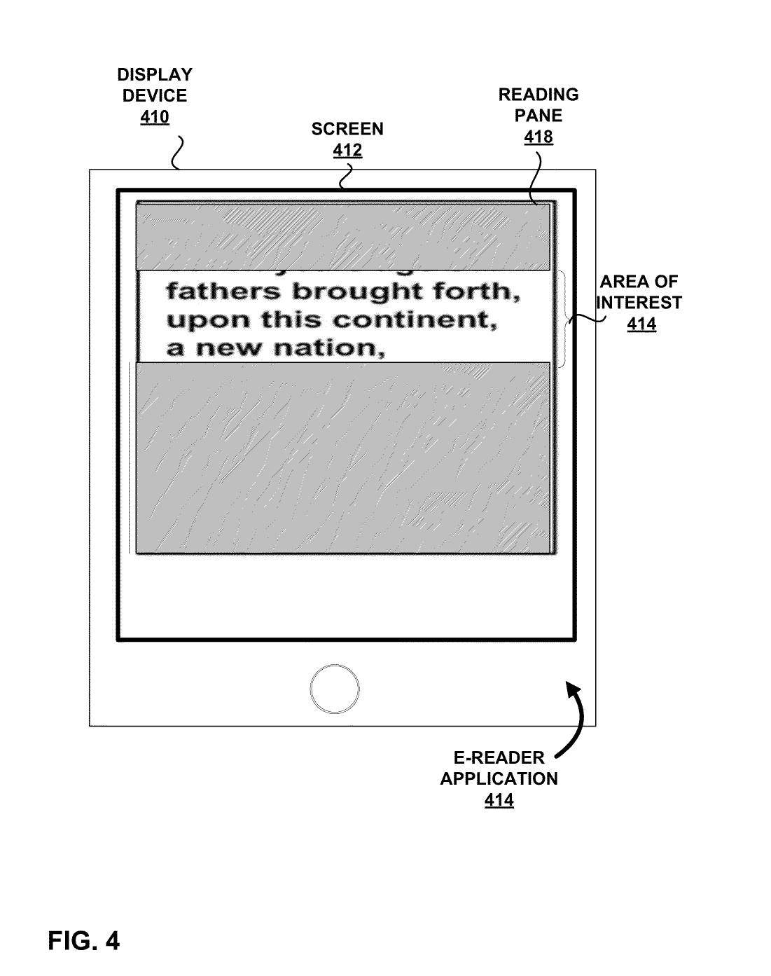

FIG. 4 is a conceptual diagram that illustrates one example of text presented via a display device 410 (hereinafter “device” 410) to reduce power consumption of device 410 consistent with the techniques described herein. For example, as shown in FIG. 4, device 410 (e.g., reading pane module 346 depicted in FIG. 3) has determined a reading pane 418. The determined reading pane 418 has a size (i.e., three lines of text in the example of FIG. 4), and a location within reading pane 418. Reading pane 418 may comprise some (as shown in the example of FIG. 4), or all, of a total area of screen 414.

As depicted in FIG. 4, device 410 (e.g., display power module 234) has modified presentation of one or more portions of screen 212 within reading pane 418 that are outside of area of interest 416. According to the example of FIG. 4, device 410 has turned off and/or reduced a brightness of portions of the reading pane 418 outside of area of interest 416. For example, device 410 may deactivate (e.g., disconnect from power source) one or more display elements of screen 412 outside of are of interest 416. As another example, device 410 may reduce the brightness (e.g., reduce a level of power supplied) to one or more portions of screen 412 outside of area of interest 416. In this manner, device 410 may operate to present the lines of text in area of interest 416, while consuming less power than if the entire reading pane 418 and/or the entire display 412 were on and/or operated the same to present text as area of interest 416.

In some examples, device 410 may operate to present text in a determined area of interest 416 as described above manually advanced based on received user input. In other examples, device 410 (e.g., automatic scroll module 230 depicted in FIG. 2) may automatically scroll text in a determined area of interest 416, as described above.

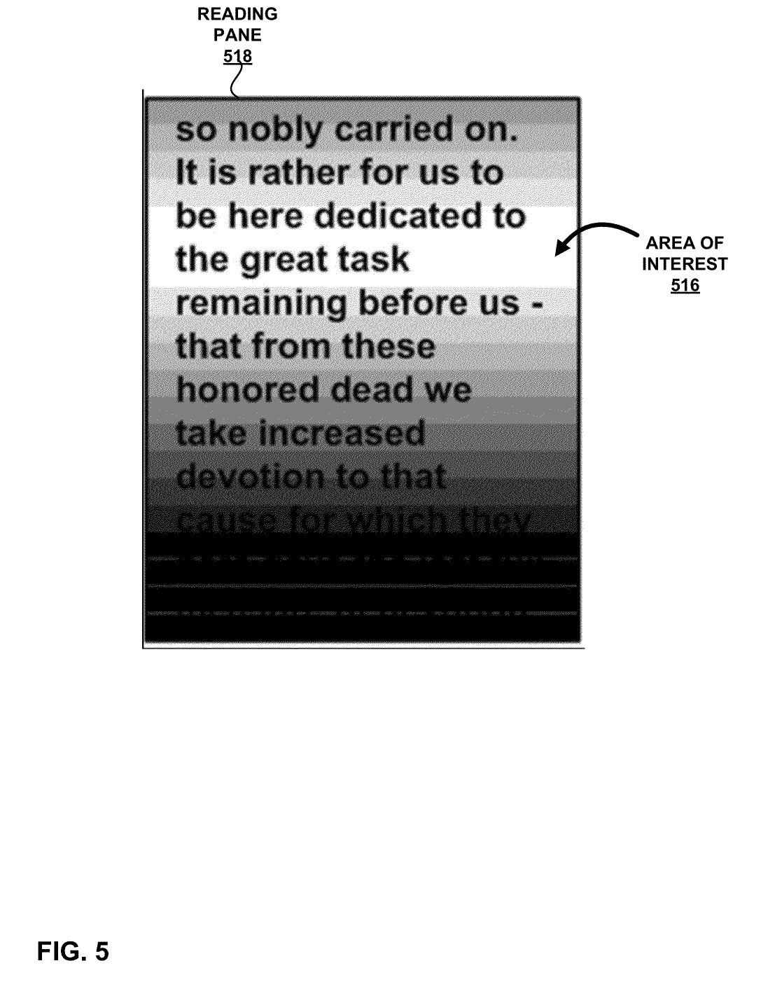

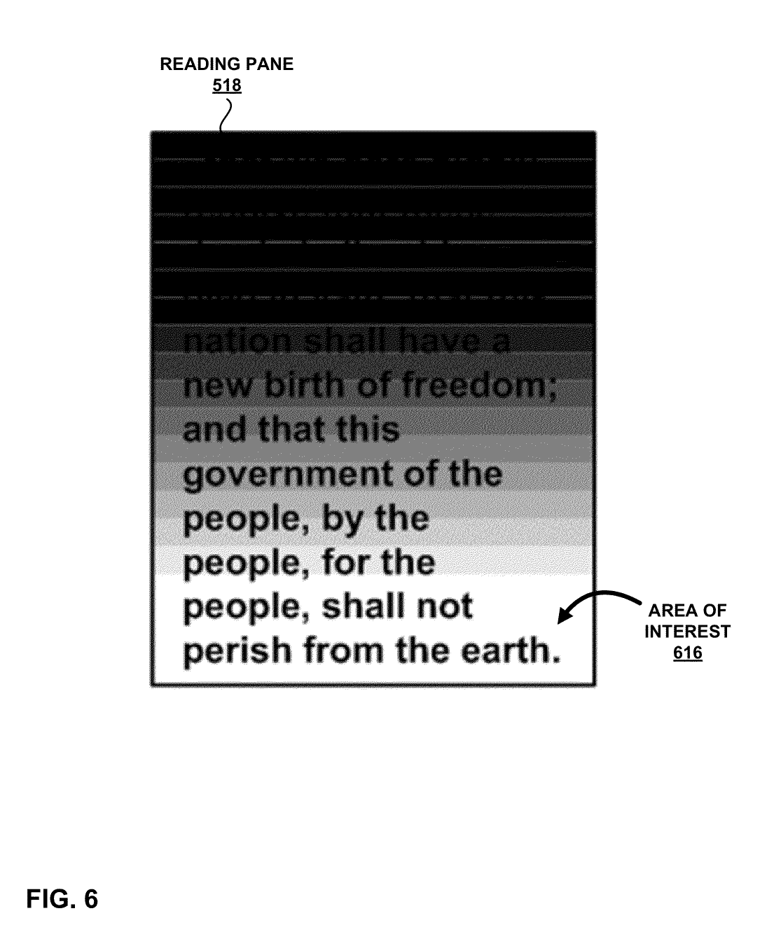

In some examples, device 410 may uniformly modify one or more portions of screen 412 outside of area of interest 416, as depicted in the example of FIG. 4, such as by uniformly turning off or reducing a brightness of non-area of interest portions of screen 412, and/or by uniformly modifying a color and/or contrast ratio of non-area of interest portions of displayed text. In other examples, device 410 may modify operation different portions of screen 412 outside of area of interest 416 differently from one another. For example, as shown in the examples of FIGS. 5 and 6, device 210 may modify different portions of screens 512, 612 differently, depending on how close the respective portions are to areas of interest 516, 616. In this manner, device 210 may provide a more comfortable reading experience to a user, while reducing power consumption of devices 510, 610 to present text.

FIG. 5 is a conceptual diagram that illustrates one example of a reading pane 518 of a display device (e.g., display device 210 depicted in FIG. 2) operated to present text with reduced power consumption consistent with the techniques described herein. As shown in FIG. 5, device 210 has determined an area of interest 516 with a size and a location within reading pane 418, and has operated to display text in the reading pane 518. According to the example of FIG. 5, device 510 has determined an area of interest 516 that comprises two lines of text “be here dedicated to” and “the great task.” Although two lines of text are illustrates in area of interest 516 for purposes of example, a greater number of lines may be used. In some example, the number of lines, or vertical or horizontal size, of area of interest 516 may be selectable, e.g., by a designer or a user.

As shown in the example of FIG. 5, device 510 has operated to modify presentation of text outside of area of interest 516 (non-area of interest text). According to the example of FIG. 5, device 210 has operated to gradually modify the presentation of text outside of area of interest 516. For example, as shown in the example of FIG. 5, device 210 has operated to gradually reduce a brightness of portions of screen 512 outside of area of interest 516 more the further the respective portions are from area of interest 516. As shown in FIG. 5, a brightness of portions of screen 512 closest to area or interest 516, i.e., where the phrases “It is rather for us to” and “remaining before us” are presented, has been reduced relative to a brightness of area of interest 516. As also shown in FIG. 5, a brightness of portions of screen 512 further from area of interest 516 is further reduced relative to a brightness of area of interest 516. For example, the brightness of portions of screen 512 where the phrase “that from these” is presented has been reduced relative to a brightness of the closer portions described above. As also shown in the FIG. 5, a brightness of portions of screen 512 where the phrases “honored dead we,” “take increased,” and “devotion to that” are presented is increasingly reduced the further the respective portion is from area of interest 516.

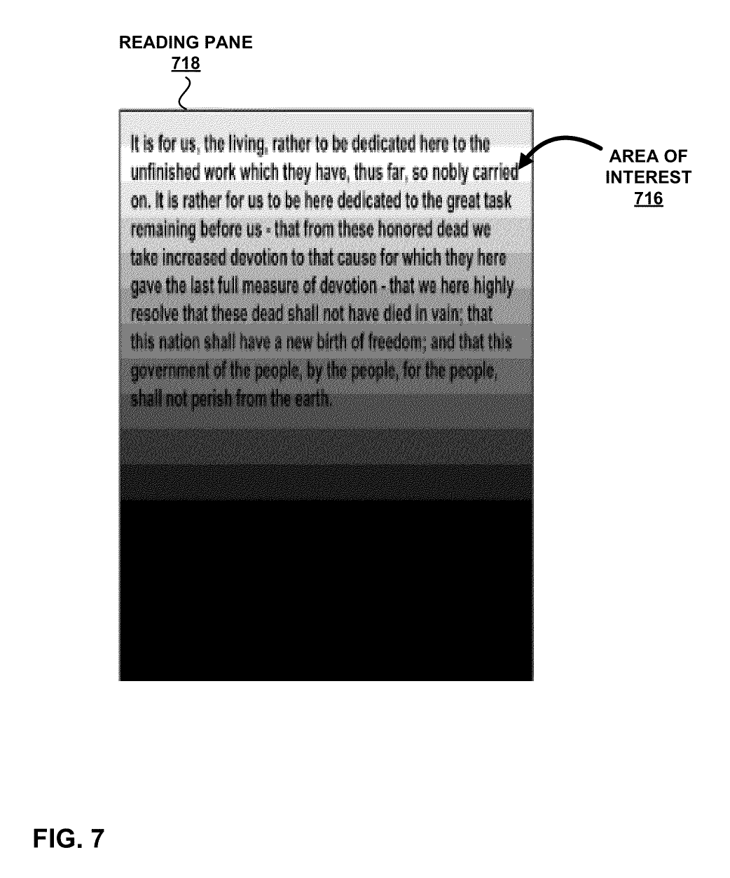

FIGS. 6 and 7 are conceptual diagrams that illustrate other examples of reading pane 618 that may be presented by a screen 212 of a display device 210 (as depicted in FIG. 2) to reduce power consumption of the device 210 to present text consistent with the techniques of this disclosure. According to the examples of FIGS. 6 and 7, display device 210 is operated to present non-uniformly modified portions of a display screen 212 outside of a determined area of interest 616, 716.

As shown in FIG. 6, device 210 has determined an area of interest 616 with a size of two lines that include the phrases “people, shall not” and “perish from the earth.” As also shown in the example of FIG. 6, device 210 has also determined a location for area of interest 616 at a bottom of reading pane 618.

As also depicted in FIG. 6, portions of screen 612 outside of area of interest 616 are non-uniformly modified. For example, as shown in FIG. 6, a brightness of a portion of screen 612 closest to area of interest 616 where the phrase “people, for the” is presented is reduced relative to a brightness of area of interest 616. As also shown in FIG. 6, the further away each respective portion of screen 612 is from area of interest 616, the more the brightness of the respective portion is reduced.

As another example, as shown in FIG. 7, device 210 has determined an area of interest 716 within reading pane 718 with a size configured to include only a single line of text. Area of interest 716 also has a location near a top of reading pane 718. As also shown in FIG. 7, portions of reading pane 718 outside of area of interest 616 are non-uniformly modified. For example, as shown in FIG. 7, the further away each respective portion of reading pane 718 is from area of interest 816, the more the brightness of the respective portion is reduced.

The examples of FIGS. 4-7 depict various examples of techniques for modifying operation of non-area of interest portions of a reading pane by either reducing a brightness of one or more portions of the reading pane, and/or turning off (i.e., disconnecting from a power source) one or more non-area of interest portions of the reading pane. These examples are provided for purposes of describing the subject matter of this disclosure, and are intended to be non-limiting. In other examples not depicted in the FIGS. 4-7, each respective device may, also or instead, modify one or more of a contrast, color, or other characteristic of text presented in non-area of interest pane portions of a screen to reduce power consumption. For example, where text presented within the area of interest are presented with a block color (e.g., high contrast with a white background), a device may change a color of text presented outside of the area of interest to be presented in a blue, red, yellow, or other color which has a lower contrast relative to a background of the displayed text. According to these examples, the device may uniformly modify color, contrast, or other characteristic of text presented in non-reading portions as shown in the example of FIG. 4, or non-uniformly (e.g., gradually) modify color, contrast, or other characteristic of displayed text, as depicted in the examples of FIGS. 5-7, to reduce power consumption of the device.

As described above with respect to FIG. 2, in some examples, device 210 may include an area of interest module 232 configured to receive user input via user input module 229, and determine an area of interest 116 within reading pane 118 based on the received user input. For example, area of interest module 232 may determine a size and/or location of area of interest 116. In some examples, such user input used to determine a reading pane may include one or more single and/or multi-touch gestures detected by device 210, such as via one or more touch sensors embedded in a display and/or other surface of device 210.

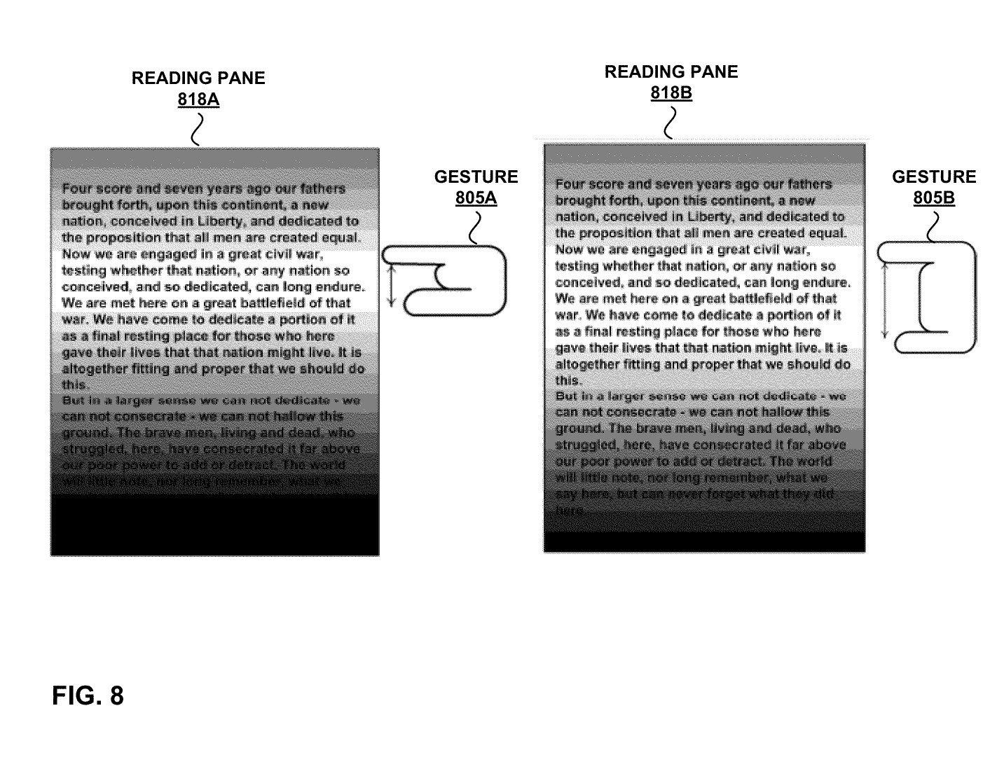

FIG. 8 is a conceptual diagram that illustrates one example of a multi-touch gesture that may be detected by device 210 and used to determine an area of interest such as area of interest 816A, 816B depicted in FIG. 8. For example, as shown in FIG. 8., reading pane 818A includes an area of interest 816A with a location at the top-center of reading pane 818A, and a size of four lines of text. As shown by reading pane 818B, a user may increase the size of the area of interest 816B relative to a size of area of interest 816A, by making contact with screen 212 at or near area of interest 816A, and spreading the user's fingers apart from one another, to indicate the larger size for reading pane 818B depicted in screen 812B. Although not depicted in the example of FIG. 8, a user may also reduce a size of an area of interest 816A, 816B, by making contact with screen 212 at or near area of interest 816A, 816B and pinching two fingers together to indicate a reduced size of the area of interest.

In other examples also not depicted in FIG. 8, device 210 may receive user input indicating a location of area of interest 116. For example, device 210 may detect one or more single or multi-touch gestures configured to move area of interest 116 at or near the top of screen 212, as shown by area of interest 716 depicted in FIG. 7, at or near the bottom of screen 212, as shown by area of interest 616 depicted in FIG. 6, and/or at or near a middle of screen 212 as shown by area of interest 516 depicted in FIG. 5.

In this manner, device 210 may determine an area of interest 116 for the presentation of text to a viewer. According to the techniques described herein, device 210 may use such a determined area of interest to present text to modify presentation and/or operation of one or more portions of screen 212 outside of the determined area of interest 116. According to each of these examples, power consumption of device 210 may be reduced, which may thereby improve a user experience when using device 210 to read text.

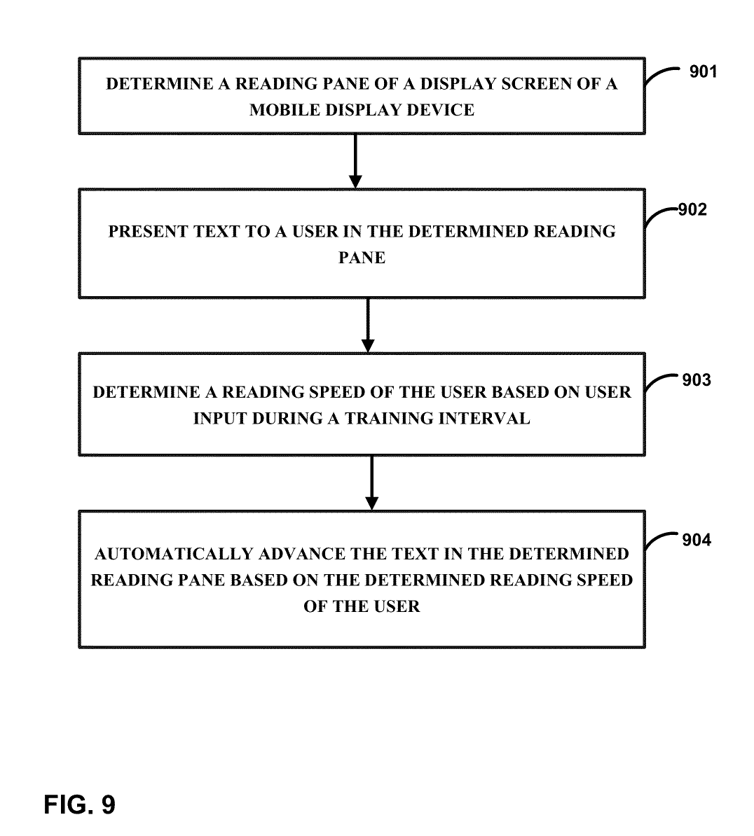

FIG. 9 is a flow diagram that illustrates one example of a method of operating a display device 210 to reduce power consumption of the display device 210 consistent with the techniques described herein. The method of FIG. 9 is described as being performed by display device 210 depicted in FIG. 2. However, any device may be used to perform the method of FIG. 9.

According to the method of FIG. 9, display device 210 (e.g., reading pane module 346 of automatic scroll module 330) may determine a reading pane 118 of a display screen 212 included in device 210 (901). For example, device 210 may determine a size and/or location of the reading pane 118 based on received user input (e.g., via user input module 229). In some examples, device 210 may determine a size of reading pane 118 that is less than an area of display screen 212.

As shown in FIG. 9, display device 210 may present text to a user in the determined reading pane (902). As also shown in FIG. 9, display device 210 (e.g., scroll speed determination module 340) may determine a reading speed of the user based on user input received during a training interval (903). For example, device 210 may track one or more of manual line scroll and/or page turn commands received (e.g., via user input module 229) as the user reads the text in a conventional manner. As another example, during the training interval, device 210 may automatically advance the text at a default speed and the user may increase or decrease the speed at which the text is advanced to match his/her reading speed.

As also depicted in FIG. 9, device 210 (e.g., speed control module 342) may automatically advance the text in the determined reading pane 118 based on the determined reading speed of the user (904). For example, device 210 may determine an automatic scroll speed that may be comfortable for the user based on the determined reading speed of the user. In some examples, device 210 may also adapt a speed at which the text is automatically advanced based on content of the displayed text. For example, device 210 may determine a lexical complexity of text to be displayed, and decrease an automatic scroll speed of the text if the text is relatively more complex, and/or increase an automatic scroll speed of the text if the text is relatively less complex. In some examples, device 210 may determine the lexical complexity of text to be displayed based on a Flesch Reading Ease Index score.

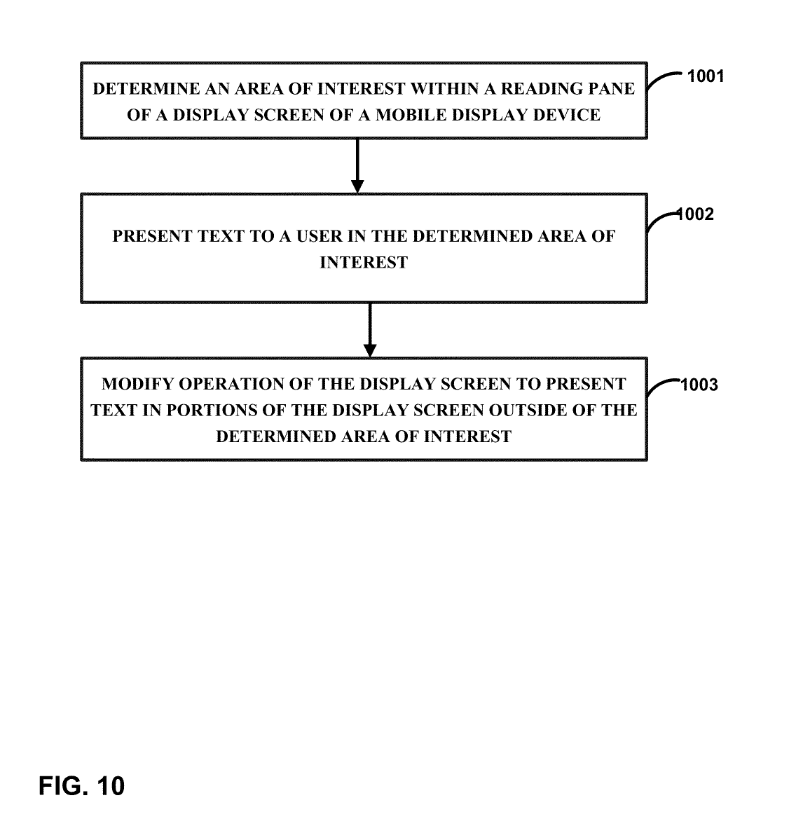

FIG. 10 is a flow diagram that illustrates one example of a method of reducing power consumption of a display device 210 operated to present text consistent with the techniques described herein. The method of FIG. 10 is described as being performed by display device 210 depicted in FIG. 2, however any device may be used to perform the method of claim 10.

As depicted in FIG. 10, device 210 may determine an area of interest 116 within a reading pane 118 of a display screen 212 of device 210 (1001). For example, device 210 may determine a size and/or position of the area of interest 116 within the reading pane 118. As also depicted in FIG. 9, device 210 may present text to a user in the determined area of interest (1002).

As also depicted in FIG. 10, device 210 may modify operation of device 210 to present text in portions of the display screen 212 (e.g., portions of the reading pane 118) outside of the determined area of interest 116 (1003). For example, device 210 may modify a brightness, contrast ratio of presented text, and/or color of presented text outside of the determined area of interest 116. In other examples, device 210 may also or instead turn off display screen 212 in one or more portions outside of the determined area of interest. In some examples, device 210 may modify operation of device 210 uniformly for all portions of reading pane 118 outside of the determined area of interest 116. In other examples, device 210 may gradually modify portions of reading pane 118 outside of the determined area of interest 116, for example, based on a distance away from area of interest 116.

The techniques described herein may be implemented in hardware, software, firmware, or any combination thereof. Any features described as modules or components may also be implemented together in an integrated logic device or separately as discrete but interoperable logic devices. If implemented in software, the techniques may be realized at least in part by a tangible computer-readable storage medium comprising instructions that, when executed, performs one or more of the methods described above. The tangible computer-readable data storage medium may form part of a computer program product, which may include packaging materials.

The tangible computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements.

Various examples have been described. These and other examples are within the scope of the following claims.

1. A method of displaying text on a mobile display device comprising:
determining a reading pane of a display screen operatively coupled with the mobile display device;
presenting text to a user in the reading pane;
determining a reading speed of the user based on user input; and
automatically advancing the text within the reading pane based on the determined reading speed of the user.

2. The method of claim 1, wherein automatically advancing the text within the reading pane comprises at least one of automatically scrolling lines of the text, automatically advancing pages of the text, or automatically advancing a reading pane within the display screen.

3. The method of claim 1, wherein determining the reading pane comprises determining one or more of a size or a location of the reading pane within the display screen.

4. The method of claim 1, wherein determining the size of the reading pane comprises determining a size of the reading pane that is less than a size of the display screen.

5. The method of claim 1, further comprising:
determining an area of interest within the reading pane based on user interface input; and
modifying operation of the mobile display device to present text outside of the determined area of interest.

6. The method of claim 5, wherein modifying operation of the mobile display device to present text outside of the determined area of interest comprises modifying one or more of:
a brightness of the display screen outside of the determined area of interest;
a contrast ratio of text presented outside of the determined area of interest;
a contrast ratio of one or more images presented outside of the determined area of interest;
a resolution of text presented outside of the determined area of interest;
a resolution of one or more images presented outside of the determined area of interest;
a font size of text presented outside of the determined area of interest;
a type of text presented outside of the determined area of interest;
a color of text presented outside of the determined area of interest; and
a color of one or more images presented outside of the determined area of interest.

7. The method of claim 5, wherein modifying operation of the mobile display device to present text outside of the determined area of interest comprises turning off at least one portion of the display screen outside of the determined area of interest.

8. The method of claim 5, further comprising:
modifying operation of the mobile display device for portions outside of the determined area of interest differently than other portions outside of the determined area of interest.

9. The method of claim 8, further comprising:
modifying operation of the mobile display device to present text in one or more portions outside of the determined area of interest based on a distance of the one or more portions from the determined area of interest.

10. The method of claim 5, wherein the display screen operatively coupled with the mobile display device comprises a multi-segment display screen, and wherein modifying operation of the mobile display device to present text outside of the determined area of interest comprises presenting the text on fewer than all segments of the multi-segment display.

11. The method of claim 1, further comprising:
determining a complexity of the text presented to the user; and
adjusting a speed at which the text is automatically advanced based at least in part on the complexity of the text.

12. The method of claim 1, further comprising adjusting a speed at which the text is automatically advanced based on user interface input.

13. The method of claim 1, wherein determining the reading speed of the user based on user input comprises presenting text to the user and monitoring one or more of a speed at which the user advances the text displayed in the reading pane and a speed at which the user turns pages of the text.

14. The method of claim 1, wherein determining the reading speed of the user based on user input comprises automatically advancing the presented text at a predetermined speed and receiving user input regarding the predetermined speed.

15. The method of claim 1, wherein determining the reading speed of the user on a mobile display based on user input comprises passively monitoring the user.

16. A mobile display device configured to display text, comprising:
a reading pane module configured to determine a reading pane of a display screen operatively coupled with the mobile display device;
a display processor that presents text to a user in the reading pane;
a scroll speed determination module that determines a reading speed of the user based on user input to the mobile display device; and
a scroll speed control module that automatically advances the text in the reading pane based on the determined reading speed of the user.

17. The device of claim 16, wherein the scroll speed control module is configured to automatically scroll lines of the text and automatically turn pages of the text.

18. The device of claim 16, wherein the reading pane module is configured to determine one or more of a size and a location of the reading pane within the display screen.

19. The device of claim 16, wherein the reading pane module is configured to determine a size of the reading pane that is less than a size of the display.

20. The device of claim 16, further comprising:
an area of interest module configured to determine an area of interest within the reading pane based on user interface input; and
a display power module configured to modify operation of the mobile display device to present text outside of the determined area of interest.

21. The device of claim 20, wherein the display power module is configured to modify one or more of:
a brightness of the display screen outside of the determined area of interest;
a contrast ratio of text presented outside of the determined area of interest;
a contrast ratio of one or more images presented outside of the determined area of interest;
a resolution of text presented outside of the determined area of interest;
a resolution of one or more images presented outside of the determined area of interest;
a font size of text presented outside of the determined area of interest;
a type of text presented outside of the determined area of interest;
a color of text presented outside of the determined area of interest; and
a color of one or more images presented outside of the determined area of interest.

22. The device of claim 20, wherein the display power module is configured to turn off at least one portion of the display screen outside of the determined area of interest.

23. The device of claim 20, wherein the display power module is configured to modify operation of the mobile display device for portions outside of the determined area of interest differently than other portions outside of the determined area of interest.

24. The device of claim 23, wherein the display power module is configured to modify operation of the mobile display device to present text in one or more portions outside of the determined area of interest based on a distance of the one or more portions from the determined area of interest.

25. The device of claim 20, wherein the display screen operatively coupled with the mobile display device comprises a multi-segment display screen, and wherein the display power module is configured to present the text on fewer than all segments of the multi-segment display.

26. The device of claim 16, further comprising a speed adaptation module configured to:
determine a complexity of the text presented to the user; and
adjust a speed at which the text is automatically advanced based on the complexity of the text.

27. The device of claim 16, further comprising a speed adaptation module configured to adjust a speed at which the text is automatically advanced based on user interface input.

28. The device of claim 16, wherein the scroll speed determination module presents text to the user and monitors one or more of a speed at which the user advances the text displayed in the reading pane and a speed at which the user turns pages of the text to determine the reading speed of the user.

29. The device of claim 16, wherein the scroll speed determination module automatically advances the presented text at a predetermined speed and receives user input regarding the predetermined speed to determine the reading speed of the user.

30. The device of claim 16, wherein the scroll speed determination module passively monitors the user to determine the reading speed of the user.

31. A computer-readable storage medium that stores instructions configured to cause a computing device to:
determine a reading pane of a display screen operatively coupled with a mobile display device;
present text to a user in the reading pane;
determine a reading speed of the user based on user input; and
automatically advance the text in the reading pane based on the determined reading speed of the user.

32. The computer-readable storage medium of claim 31, wherein the instructions cause the computing device to automatically scroll lines of the text and automatically turn pages of the text.

33. The computer-readable storage medium of claim 31, wherein the instructions cause the computing device to determine one or more of a size and a location of the reading pane within the display screen.

34. The computer-readable storage medium of claim 31, wherein the instructions cause the computing device to determine a size of the reading pane that is less than a size of the display.

35. The computer-readable storage medium of claim 31, wherein the instructions cause the computing device to:
determine an area of interest within the reading pane based on user interface input; and
modify operation of the mobile display device to present text outside of the determined area of interest.

36. The computer-readable storage medium of claim 35, wherein the instructions cause the computing device to modify one or more of:
a brightness of the display screen outside of the determined area of interest;
a contrast ratio of text presented outside of the determined area of interest;
a contrast ratio of one or more images presented outside of the determined area of interest;
a resolution of text presented outside of the determined area of interest;
a resolution of one or more images presented outside of the determined area of interest;
a font size of text presented outside of the determined area of interest;
a type of text presented outside of the determined area of interest;
a color of text presented outside of the determined area of interest; and
a color of one or more images presented outside of the determined area of interest.

37. The computer-readable storage medium of claim 35, wherein the instructions cause the computing device to turn off at least one portion of the display screen outside of the determined area of interest.

38. The computer-readable storage medium of claim 35, wherein the instructions cause the computing device to modify operation of the mobile display device for portions outside of the determined area of interest differently than other portions outside of the determined area of interest.

39. The computer-readable storage medium of claim 38, wherein the instructions cause the computing device to modify operation of the mobile display device to present text in one or more portions outside of the determined area of interest based on a distance of the one or more portions from the determined area of interest.

40. The computer-readable storage medium of claim 35, wherein the display screen operatively coupled with the mobile display device comprises a multi-segment display screen, and wherein the instructions cause the computing device to present the text on fewer than all segments of the multi-segment display.

41. The computer-readable storage medium of claim 31, wherein the instructions cause the computing device to:
determine a complexity of the text presented to the user; and
adjust a speed at which the text is automatically advanced based on the complexity of the text.

42. The computer-readable storage medium of claim 31, wherein the instructions cause the computing device to adjust a speed at which the text is automatically advanced based on user interface input.

43. The computer-readable storage medium of claim 31, wherein the instructions cause the computing device to present text to the user and monitor one or more of a speed at which the user advances the text displayed in the reading pane and a speed at which the user turns pages of the text to determine the reading speed of the user.

44. The computer-readable storage medium of claim 31, wherein the instructions cause the computing device to automatically advance the presented text at a predetermined speed and receive user input regarding the predetermined speed to determine the reading speed of the user.

45. The computer-readable storage medium of claim 31, wherein the instructions cause the computing device to passively monitor the user to determine the reading speed of the user.

46. A mobile display device comprising:
means for determining a reading pane of a display screen operatively coupled with the mobile display device;
means for presenting text to a user in the reading pane;
means for determining a reading speed of the user on a mobile display based on user input; and
means for automatically advancing the text in the reading pane based on the determined reading speed of the user.

47. A method of displaying text using a mobile display device comprising:
determining an area of interest within a reading pane presented via a mobile display device;
automatically advancing text presented in the determined area of interest; and
modifying operation of the mobile display device to present text outside of the determined area of interest.

48. The method of claim 47, wherein modifying operation of the mobile display device to present text outside of the determined area of interest comprises modifying one or more of:
a brightness of the display screen outside of the determined area of interest;
a contrast ratio of text presented outside of the determined area of interest;
a contrast ratio of one or more images presented outside of the determined area of interest;
a resolution of text presented outside of the determined area of interest;
a resolution of one or more images presented outside of the determined area of interest;
a font size of text presented outside of the determined area of interest;
a type of text presented outside of the determined area of interest;
a color of text presented outside of the determined area of interest; and
a color of one or more images presented outside of the determined area of interest.

49. The method of claim 47, wherein modifying operation of the mobile display device to present text outside of the determined area of interest comprises turning off at least one portion of the display screen outside of the determined area of interest.

50. A mobile display device comprising:
an area of interest module configured to determine an area of interest within a reading pane presented via a mobile display device;
a scroll speed control module that automatically advances text presented in the determined area of interest; and
a display power module configured to modify operation of the mobile display device to present text outside of the determined area of interest.

51. The device of claim 50, wherein the display power module is configured to modify one or more of:
a brightness of the display screen outside of the determined area of interest;
a contrast ratio of text presented outside of the determined area of interest;
a contrast ratio of one or more images presented outside of the determined area of interest;
a resolution of text presented outside of the determined area of interest;
a resolution of one or more images presented outside of the determined area of interest;
a font size of text presented outside of the determined area of interest;
a type of text presented outside of the determined area of interest;
a color of text presented outside of the determined area of interest; and
a color of one or more images presented outside of the determined area of interest.

52. The method of claim 50, wherein the display control module is configured to modify operation of the mobile display device to present text outside of the determined area of interest via turning off at least one portion of the display screen outside of the determined area of interest.

53. A computer-readable storage medium that stores instructions configured to cause a computing device to:
determine an area of interest within a reading pane presented via a mobile display device;
automatically advance text presented in the determined area of interest; and
modify operation of the mobile display device to present text outside of the determined area of interest.

54. The device of claim 53, wherein the instructions further cause the computing device to modify one or more of:
a brightness of the display screen outside of the determined area of interest;
a contrast ratio of text presented outside of the determined area of interest;
a contrast ratio of one or more images presented outside of the determined area of interest;
a resolution of text presented outside of the determined area of interest;
a resolution of one or more images presented outside of the determined area of interest;
a font size of text presented outside of the determined area of interest;
a type of text presented outside of the determined area of interest;
a color of text presented outside of the determined area of interest; and
a color of one or more images presented outside of the determined area of interest.

55. The method of claim 53, wherein the instructions further cause the computing device to modify operation of the mobile display device to present text outside of the determined area of interest via turning off at least one portion of the display screen outside of the determined area of interest.

56. A device configured to display text using a mobile display device comprising:
means for determining an area of interest within a reading pane presented via a mobile display device;
means for automatically advancing text presented in the determined area of interest; and
means for modifying operation of the mobile display device to present text outside of the determined area of interest.
